(19) United States
(12) Patent Application Publication
(10) Pub. No.: US 2017/0169385 A1
(43) Pub. Date: Jun. 15, 2017

(54) METHOD AND APPARATUS FOR DELIVERING ITEMS

(71) Applicant: Wal-Mart Stores, Inc., Bentonville, AR (US)

(72) Inventors: Donald R. High, Noel, MO (US); Anton Valkov, San Francisco, CA (US); Chandrashekar Natarajan, Valencia, CA (US)

(21) Appl. No.: 15/372,668

(22) Filed: Dec. 8, 2016

Related U.S. Application Data
(60) Provisional application No. 62/267,443, filed on Dec. 15, 2015.

(51) Int. Cl. G06Q 10/08

(52) U.S. Cl. CPC G06Q 10/083

(57) ABSTRACT

A retail sales facility that includes a plurality of items offered for sale to remote customers further includes at least one delivery vehicle configured to carry ordered items to customer-specified delivery addresses. A corresponding control circuit receives information from remote customers regarding items to be ordered and delivered along with information specifying a delivery address and a desired timeframe for delivery of the item. The control circuit automatically uses the delivery address and the desired timeframe to present the remote customer with a corresponding delivery cost and to also present at least one suggestion regarding at least one delivery parameter that, if modified, would result in a reduced delivery cost. When the remote customer responds to the at least one suggestion, the control circuit automatically modifies the corresponding delivery cost.

### CROSS REFERENCE TO RELATED APPLICATION

This application claims benefit of U.S. Provisional Application No. 62/267,443, filed Dec. 15, 2015, and is incorporated herein by reference in its entirety.

### TECHNICAL FIELD

These teachings relate generally to the delivery of items.

### BACKGROUND

Increasingly, many retail sales include delivering a purchased item to an off-site delivery address provided by the customer (such as their home, place of business, school, or the like). In some cases the retailer simply adds an actual cost of delivering the item to the cost of the item itself as the price to be paid by the customer. In other cases the retailer uses a “cost of delivery” that only approximately equals the actual cost of delivery in the hopes that, over many deliveries, the overall cost of delivery will be borne more by the customers (at least in the aggregate) than by the retailer. In yet other cases, the retailer employs the “cost of delivery” as a profit center in and of itself or offers “free” delivery where the cost of delivery is buried in the price of the item rather than expressed as a separate line item.

In virtually all of these pricing paradigms there are numerous opportunities for inefficiencies to arise. These inefficiencies, in turn, will typically ultimately result in an increased cost of delivery to at least some customers beyond what might otherwise be possible. In particular, there is little that the average customer can do to control the cost of delivery aside from the occasional opportunity to select between different speeds of delivery and/or different delivery services (such as between the United States Postal Service and United Parcel Service or FedEx).

### BRIEF DESCRIPTION OF THE DRAWINGS

The above needs are at least partially met through provision of the method and apparatus for delivering items described in the following detailed description, particularly when studied in conjunction with the drawings, wherein:

FIG. 1 comprises a flow diagram as configured in accordance with various embodiments of these teachings;

FIG. 2 comprises a block diagram as configured in accordance with various embodiments of these teachings; and

FIG. 3 comprises a schematic screen shot as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a retail sales facility that includes a plurality of items offered for sale to remote customers further includes at least one delivery vehicle configured to carry ordered items to customer-specified delivery addresses. A corresponding control circuit receives information from remote customers regarding items to be ordered and delivered along with information specifying a delivery address and a desired timeframe for delivery of the item. The control circuit automatically uses the delivery address and the desired timeframe to present the remote customer with a corresponding delivery cost and to also present at least one suggestion regarding at least one delivery parameter that would result in a reduced delivery cost. When the remote customer responds to the at least one suggestion, the control circuit automatically modifies the corresponding delivery cost.

By one approach, the control circuit calculates the delivery cost as a function of a base delivery charge that is modified to account for one or more delivery parameters that pertain to delivering the item. The delivery parameter can be developed, for example, as a function of video analytics of satellite imagery of the delivery address, forecast traffic congestion corresponding to delivering to the delivery address, a number of stairs at the delivery address that must be traversed to deliver the item, how level a parking area is for a delivery vehicle at the delivery address, care beyond a level of care that is associated with the base delivery charge, and a margin of profit that corresponds to items being ordered by the remote customer, to note but a few examples in these regards.

These teachings are highly flexible in practice and will accommodate a variety of modifications and variations. The aforementioned suggestion regarding at least one delivery parameter that can be modified to reduce the delivery price, for example, can comprise suggestions regarding at least one alternative timeframe for delivery of the item, an alternative delivery address, an alternative number of items to be delivered, joining the remote customer's order to another customer's order, substituting a generic item comparable to the item to be delivered, and so forth.

So configured, these teachings will accommodate a wide variety of suggestion possibilities by which a customer can better and more creatively and interactively control a delivery price associated with their ordered items. By one approach the customer can be effectively financially rewarded when selecting delivery suggestions that, in turn, reduce delivery costs and/or increase a profit margin for the retail sales facility.

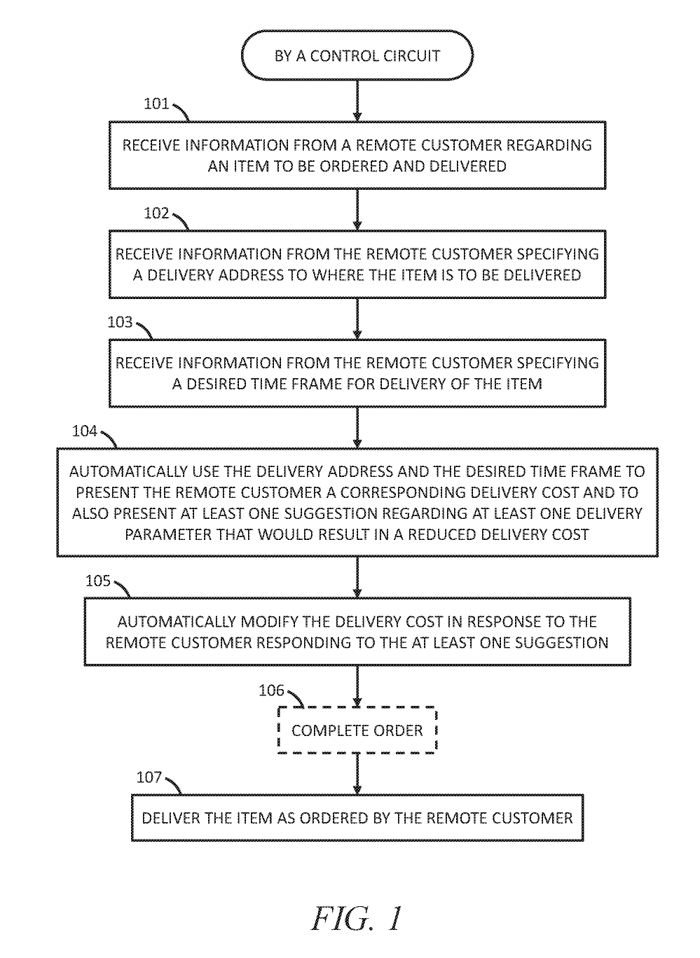

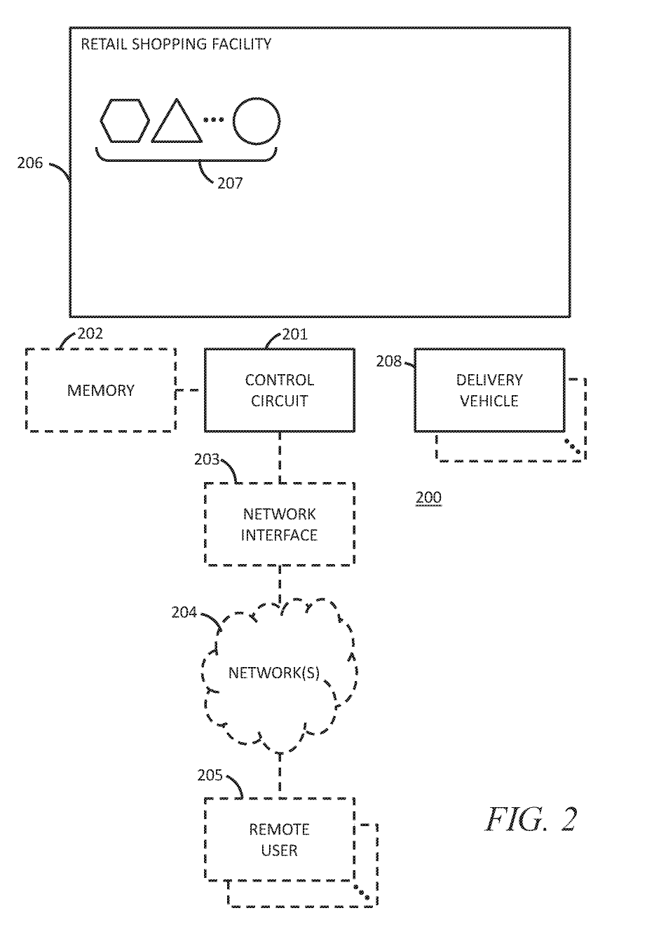

These and other benefits may become clearer upon making a thorough review and study of the following detailed description. Referring now to the drawings, and in particular to FIG. 1, an illustrative process 100 that is compatible with many of these teachings will now be presented. For the sake of an illustrative example it will be presumed here that some or all the various steps, actions, and functions described with respect to FIG. 1 are carried out by a control circuit of choice. FIG. 2 presents an illustrative application setting.

As shown in FIG. 2, by one approach the enabling apparatus 200 includes a control circuit 201. Being a “circuit,” the control circuit 201 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 201 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 201 is configured (for example, by using corresponding programming as will be well understood by those skilled in the art) to carry out one or more of the steps, actions, and/or functions described herein.

By one optional approach the control circuit 201 operably couples to a memory 202. This memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

In addition to other information described herein, this memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 201 also operably couples to a network interface 203. So configured the control circuit 201 can communicate with other elements (both within the apparatus 200 and external thereto) via the network interface 203. Network interfaces, including both wireless and non-wireless platforms, are well understood in the art and require no particular elaboration here.

In particular, the control circuit 201 can compatibly communicate via one or more networks 204 with one or more remote users 205. The one or more networks 204 can comprise any of a variety of wireless and non-wireless data/communication networks as are known in the art. By one approach, for example, the network 204 comprises the Internet. The remote users 205 can, in turn, communicate with the control circuit 201 via any of a variety of communications devices including but not limited to so-called smart phones, tablet and laptop computers, desktop computers, appropriately-configured kiosks, and so forth.

In this example the apparatus 200 further includes a retail shopping facility 206 that includes a plurality of items 207 that are offered for sale to remote customers such as the aforementioned remote users 205. In this example the retail shopping facility 206 comprises a retail sales facility or any other type of bricks-and-mortar (i.e., physical) facility in which products such as the items 207 are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size of format facility, and may include products from one or more merchants. For example, a facility may be a single store operated by one merchant or may be a collection of stores covering multiple merchants such as a mall.

As is also shown in FIG. 2, the apparatus 200 further includes one or more delivery vehicles 208 that are configured to carry ordered items 207 to a corresponding customer-specified delivery address. These teachings will accommodate a great variety of different kinds of delivery vehicles including vehicles that employ any of a variety of locomotion and transport modalities. The delivery vehicle may comprise, for example, a terrestrial vehicle (such as an automobile, a van, or a truck), an airborne vehicle (such as an unmanned drone), an aquatic vehicle, or any combination of the foregoing. The delivery vehicle may either be manned or unmanned as desired.

With continued reference to both FIGS. 1 and 2, at block 101 the control circuit 201 receives information (via, for example, the aforementioned network interface 203 and network 204) from a remote customer (such as the aforementioned remote user 205) regarding an item 207 to be ordered and delivered. By one approach the control circuit 201 receives this information via a browser interface as is well known and understood in the art.

At block 102 the control circuit 201 receives information from the remote customer specifying a delivery address to where the item is to be delivered. As used herein, a “delivery address” will be understood to refer to a physical address and not, for example, a communications network address such as an ISP number, an email account identifier, or the like. Accordingly, and by way of example, the delivery address may be a standard street address (which may or may not include a unit number such as an apartment number), a Post Office box or the like, a particular latitude and longitude, or a reference to a recognizable street intersection, landmark, building name, or the like.

At block 103 the control circuit 201 receives information from the remote customer specifying a desired timeframe for delivery of the item. This timeframe may constitute a particular day or day and time of day by when the item shall be delivered. By another approach this timeframe may constitute a range of time during when the item shall be delivered (such as a range of times of day on a particular day or a range that spans a number of days).

By one approach the remote customer specifically provides the information that specifies the desired timeframe. By another approach the remote customer selects from amongst a number of presented options in these regards. When a number of different standard options are available, these teachings will accommodate initially presenting the remote customer with one or more pre-selected default choices in these regards (such as “standard” delivery, “two-day” delivery, and so forth).

At block 104 the control circuit 201 automatically uses the delivery address and the desired timeframe to present the remote customer with a corresponding delivery cost. This activity can include calculating the corresponding delivery cost as a function of a base delivery charge. The base delivery charge may comprise a standard base delivery charge that the retail shopping facility 206 applies with respect to all deliveries, or at least with respect to deliveries of items of a particular kind, size, weight, or the like.

By another approach, the base delivery is then modified (higher or lower) based upon one or more delivery parameters that pertain to delivering the item to the specified delivery address. As one example in these regards, the delivery parameter that pertains to delivering the item can be determined as a function of video analytics of satellite imagery of the delivery address. Video analytics of satellite imagery comprises a generally well-understood area of prior art endeavor that can be carried out by the control circuit 201 or by a remote service that the control circuit 201 accesses via the aforementioned network 204.

Video analytics can provide, for example, information regarding such things as details regarding the road or roads that lead to the delivery address, and so forth. Other examples include but are not limited to information regarding the types of structures or open areas (such as vacant lots), schools, recreation fields, parks, and so forth that that may be nearby the delivery address. When the underlying video content is real time or near real time, the video analytics can provide, for example, information regarding such things as parades, funeral processions, emergency equipment, road construction, road cleaning equipment, temporarily-blocked off areas, heavy tree coverage of area, traffic jams, and weather conditions (snow, ice, rain, and so forth), crowds of people, children playing, and so forth, all of which may factor in to how readily a delivery can be conveniently executed at the delivery address.

As another example in these regards, the delivery parameter that pertains to delivering the item can be determined as a function of forecast traffic congestion corresponding to delivering to the delivery address. For example, when the specified time of delivery is likely to necessarily require the delivery vehicle 208 to travel when one or more roads that lead to the delivery address will likely be congested with traffic, the additional transit time required due to such congestion can serve to increase the delivery cost beyond the base delivery charge.

As yet another example in these regards, the delivery parameter that pertains to delivering the item can represent a number of stairs at the delivery address that must be traversed to deliver the item. When, for example, the delivery address is on the third floor of a building that has no elevator, the delivery cost can be increased beyond the base delivery charge to take into account the time that the delivery associate must expend to walk up those two flights of stairs to make the delivery and to then walk back down those two flights of stairs to return to the delivery vehicle 208.

As yet another example in these regards, the delivery parameter that pertains to delivering the item can represent how level a parking area is for the delivery vehicle 208 at the delivery address. When, for example, a seemingly convenient parking area also harbors an incline that will either make removing the item from the delivery vehicle 208 considerably more difficult or even unsafe or impossible, it may be necessary to employ a less convenient parking area that is sufficiently level. In such a case, the delivery cost can be increased beyond the base delivery charge to take into account the additional time that might be expended to drive to that less convenient parking area and certainly to account for the additional time the delivery associate must expend in order to transport the item from the delivery vehicle 208 to the delivery address.

As yet another example in these regards, the delivery parameter that pertains to delivering the item can represent whether delivery of the item requires care beyond a level of care that is normally associated with the base delivery charge. Such can be the case when, for example, the item is particularly fragile, or is of a size that renders handling of the item less convenient and manageable, or where the item must be maintained in a particular orientation during handling, to note but a few possibilities in these regards. In such a case, the delivery cost can be increased beyond the base delivery charge to take into account the additional time that the delivery associate must expend to observe the additional level of care when making the delivery.

These teachings can account for other related concerns as well. For example, by one approach, the aforementioned base delivery charge can be modified to account for a margin of profit that corresponds to items being ordered by the remote customer. When the margin of profit is sufficiently high, for example, the base delivery charge can be reduced if desired. When the margin of profit is particularly slim, however, the base delivery charge can be increased if desired.

And as yet another example in these regards, the aforementioned base delivery charge can be modified to account for (actual or predicted) weather conditions that correspond to delivering to the delivery address when those weather conditions can be expected to increase the time required to make the delivery for whatever reason.

With continued reference to block 104, in addition to automatically using the delivery address and the desired timeframe to present the remote customer with a corresponding delivery cost, the control circuit 201 also presents at least one suggestion regarding at least one delivery parameter that would result in a reduced delivery cost (in particular, a suggestion regarding a delivery parameter that can be modified to yield such a reduction).

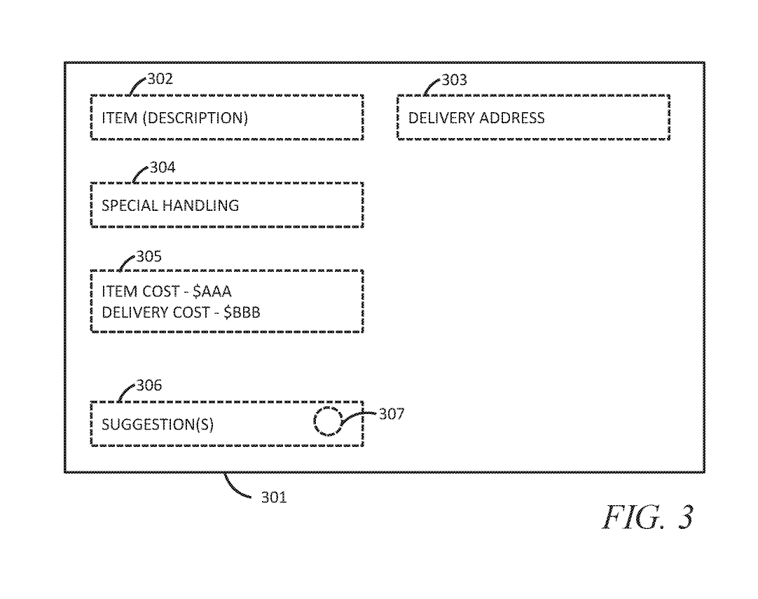

FIG. 3 presents an illustrative example in these regards. This example comprises a screenshot 301 that the control circuit 201 provides to the remote user 205 via the latter's corresponding device using, for example, a browser-based interface. As illustrated, this interface provides a description of the item 302 and the delivery address 303. Special handling instructions 304, if any, are also indicated if desired. Reference numeral 305 refers to one or more fields where the cost of the item and the aforementioned calculated cost of delivery are presented. And reference numeral 306 refers to an area where one or more suggestions are presented that pertain to modifiable delivery parameters that can result in a reduced delivery cost. By one approach, a button 307 or other user-assertable device provides a way for the remote customer to select a particular suggestion.

These teachings are highly flexible in practice and will accommodate a wide variety of delivery parameters that can form the basis of such a suggestion. As one example in these regards, the suggestion can comprise at least one alternative timeframe for delivery of the item. In some cases this can constitute a suggestion that the delivery deadline be extended further out or that a permissible delivery window be expanded. In other cases the suggestion might pertain to delivering the item sooner (where, for example, a local delivery is already scheduled for a delivery address that is very near the currently-specified delivery address such that the retail shopping facility 206 can achieve a reduced cost by consolidating the two deliveries).

As another example in these regards, the suggestion can comprise an alternative delivery address. When, for example, the present delivery address will require the delivery associate to use one or more lengthy stairways, the suggestion may constitute an alternative floor at the delivery address (such as a manager's office on the first floor of a multi-floor apartment building). Or, when the present delivery address will require the delivery associate to park the delivery vehicle 208 a considerable distance from the delivery address, the suggestion may constitute an alternative location that is convenient to the remote customer and that will not require the delivery vehicle 208 to be part at such a distance.

As another example in these regards, the suggestion can comprise an alternative number of the item to be delivered. For example, by ordering, say, four or more of the items, the delivery price for this remote customer may be less than the delivery price for delivering only one such item.

As another example in these regards, the suggestion can comprise joining the remote customer's order of the item to another customer's order (regardless of whether the other customer has ordered the same item or not). This “joining” of the orders might comprise, for example, agreeing to deliver both orders to a same delivery address (which may or may not be the same as the original delivery address specified by this remote customer) at the same time. Or, by another approach, this “joining” of the orders might comprise the remote customer prompting, say, a neighbor to initiate a new order, which order can be joined to the remote customer's present order.

As yet another approach in these regards, the suggestion can comprise substituting a generic item that is comparable to the item to be delivered. Because a retailer will often realize an increased profit margin for so-called generic items (which can include a so-called house brand), by switching from a third-party non-house brand to a generic item the resultant increased profit margin can serve as the basis for reducing the delivery cost.

It will be understood that the foregoing examples are intended to serve as illustrative examples and are not intended to suggest any particular limitations in these regards.

By one approach, the potential savings and/or the resultant reduced delivery cost can be co-presented with each of the foregoing suggestions. By another approach, the resultant reduced delivery price (with or without the separately-identified resultant savings) can be presented in response to the remote user 205 selecting a particular suggestion. In any event, at block 105 the control circuit 201 automatically modifies the delivery cost in response to the remote customer responding to at least one such suggestion by electing a particular such suggestion.

Following any other selections, actions, exchanges of data, or the like to complete the order 106, at block 107 the item or items as ordered by the remote customer are delivered. The control circuit 201 may support that delivery by, for example, placing the order into an active state, by arranging for other logistical assignments, and so forth. This delivery step will also include the physical movement of the ordered item from one location (such as the aforementioned retail shopping facility 206 or a manufacturer's dropship location) to the agreed-upon delivery address for the customer.

So configured, these teachings help the customer to understand at least some available options by which their delivery cost can be reduced or even minimized and to effect one or more alternatives in those regards. The resultant reduction in costs can benefit the retailer and will certainly benefit the customer. The aforementioned suggestion format provides a highly intuitive interface mechanism and the above-described approach to calculating an initial delivery price can help ensure that delivery costs are equitably calculated on a per-customer basis.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method comprising:
by a control circuit:
receiving information from a remote customer regarding an item to be ordered and delivered;
receiving information from the remote customer specifying a delivery address to where the item is to be delivered;
receiving information from the remote customer specifying a desired time frame for delivery of the item;
automatically using the delivery address and the desired time frame to present the remote customer a corresponding delivery cost and to also present at least one suggestion regarding at least one delivery parameter that would result in a reduced delivery cost;
automatically modifying the delivery cost in response to the remote customer responding to the at least one suggestion;
physically delivering the item as ordered by the remote customer.

2. The method of claim 1 wherein the suggestion comprises at least one alternative time frame for delivery of the item.

3. The method of claim 1 wherein the suggestion comprises an alternative delivery address.

4. The method of claim 3 wherein the alternative delivery address comprises an alternative floor at the delivery address.

5. The method of claim 1 wherein the suggestion comprises an alternative number of the item to be delivered.

6. The method of claim 1 wherein the suggestion comprises joining the remote customer's order of the item to another customer's order.

7. The method of claim 1 wherein the suggestion comprises substituting a generic item comparable to the item to be delivered.

8. The method of claim 1 wherein using the delivery address and the desired time frame to present the remote customer a corresponding delivery cost comprises calculating the corresponding delivery cost as a function of a base delivery charge.

9. The method of claim 8 wherein calculating the corresponding delivery cost as a function of a base delivery charge comprises modifying the base delivery charge to account for at least one delivery parameter that pertains to delivering the item.

10. The method of claim 9 further comprising determining the at least one delivery parameter that pertains to delivering the item as a function of video analytics of satellite imagery of the delivery address.

11. The method of claim 9 further comprising determining the at least one delivery parameter that pertains to delivering the item as a function of forecast traffic congestion corresponding to delivering to the delivery address.

12. The method of claim 9 further comprising determining the at least one delivery parameter that pertains to delivering the item as a function of stairs at the delivery address that must be traversed to deliver the item.

13. The method of claim 9 further comprising determining the at least one delivery parameter that pertains to delivering the item as a function of how level a parking area is for a delivery vehicle at the delivery address.

14. The method of claim 9 further comprising determining the at least one delivery parameter that pertains to delivering the item as a function of whether delivery of the item requires care beyond a level of care that is associated with the base delivery charge.

15. The method of claim 8 wherein calculating the corresponding delivery cost as a function of a base delivery charge comprises modifying the base delivery charge to account for a margin of profit that corresponds to items being ordered by the remote customer.

16. An apparatus comprising:
a retail sales facility that includes a plurality of items offered for sale to remote customers;
at least one delivery vehicle configured to carry ordered items to customer-specified delivery addresses;
a control circuit configured to:
receive information from a remote customer regarding an item to be ordered and delivered;
receive information from the remote customer specifying a delivery address to where the item is to be delivered;
receive information from the remote customer specifying a desired time frame for delivery of the item;
automatically use the delivery address and the desired time frame to present the remote customer a corresponding delivery cost and to also present at least one suggestion regarding at least one delivery parameter that would result in a reduced delivery cost;
automatically modify the delivery cost in response to the remote customer responding to the at least one suggestion.

17. The apparatus of claim 16 wherein the control circuit is configured to interact with the remote customer to receive the information regarding the item to be ordered and delivered, the information specifying the delivery address, and the desired time frame for delivery of the item via at least one of a browser interface and a mobile-device app.

18. The apparatus of claim 16 wherein the suggestion comprises at least two of:
at least one alternative time frame for delivery of the item;
an alternative delivery address;
an alternative floor at the delivery address;
an alternative number of the item to be delivered;
joining the remote customer's order of the item to another customer's order;
substituting a generic item comparable to the item to be delivered.

19. The apparatus of claim 18 wherein the control circuit is configured to use the delivery address and the desired time frame to present the remote customer the corresponding delivery cost by calculating the corresponding delivery cost as a function of a base delivery charge.

20. The apparatus of claim 19 wherein the control circuit is further configured to calculate the corresponding delivery cost by modifying the base delivery charge to account for at least one delivery parameter that pertains to delivering the item, wherein the at least one delivery parameter corresponds to at least one of:
video analytics of satellite imagery of the delivery address;
forecast traffic congestion corresponding to delivering to the delivery address;
stairs at the delivery address that must be traversed to deliver the item;
how level a parking area is for a delivery vehicle at the delivery address;
whether delivery of the item requires care beyond a level of care that is associated with the base delivery charge;
weather conditions corresponding to delivering to the delivery address.
